(19) United States
(12) Patent Application Publication
(10) Pub. No.: US 2020/0023479 A1
(43) Pub. Date: Jan. 23, 2020

(54) DIE TRANSFER METHOD AND DIE TRANSFER SYSTEM THEREOF

(71) Applicant: AeroTrans Technology Co., Ltd., Taipei City 110 (TW)

(72) Inventor: I-Chun Lin, Taipei City (TW)

(21) Appl. No.: 16/505,869

(22) Filed: Jul. 9, 2019

(30) Foreign Application Priority Data
Jul. 23, 2018 (TW) 107125365

(51) Int. Cl. B23Q 1/40; B21D 37/14; B23Q 1/26; B30B 15/02

(52) U.S. Cl. CPC B23Q 1/40; B30B 15/028; B23Q 1/262; B21D 37/14

(57) ABSTRACT

A die transfer method and a die transfer system thereof are disclosed. The die transfer method includes the following steps: providing a wafer to generate a plurality of dies; transferring a plurality of dies to a surface of a donor substrate to fix the plurality of dies on the surface of the donor substrate by a photoreactive adhesive layer; aligning the donor substrate with a target substrate, wherein the target substrate has a landing site and the position of at least one die corresponds to the position of the landing site; irradiating the donor substrate with a radiation beam to cause the photoreactive adhesive layer to drop the at least one die, such that the at least one die is transferred onto the landing site of the target substrate; and fixing the at least one die at the landing site.

### BACKGROUND OF THE INVENTION

### 1. Field of the Invention

The present invention relates to a die transfer method and a die transfer system thereof, particularly to a die transfer method using light reaction for transfer and a die transfer system thereof.

### 2. Description of the Related Art

With the advancement of technology, the electronic die has become widely used in various electronic devices. Nevertheless, several methods for arranging the electronic die on a substrate, such as Surface Mount Technology (SMT), Wafer-to-Wafer Transfer, Electrostatic Transfer, Elastomer Stamp, Micro Transfer (aTP), Fluidic Assembly and other technologies, have been disclosed in the prior art.

Surface Mount Technology (SMT) enables die to be individually packaged into a surface mount device (SMD) and then made into a tape. As such, the component stage is completed. The tape is loaded into a surface mounter, and each SMD is individually mounted on a circuit board using a vacuum nozzle. Then the SMDs are fixed onto the substrate by a reflow oven. However, with this method, only one die can be transferred by one head at a time, and the corresponding die size or the form of the circuit substrate is limited. In Wafer-to-Wafer Transfer, the original substrate of the die is bonded to the target substrate, and then the original substrate is peeled off to transfer the die to the target substrate. However, the original substrate of this method must be the same size as the target substrate, and the distances between the original substrate and the die on the target substrate must be the same, or the die cannot be selectively transferred. In Electrostatic Transfer, electrostatic force is used to pick up, transfer, and place the die on the target substrate. However, this electrostatic method is liable to cause damage to the die, for the ESD (Electro Static Discharge) or the hard contact during transfer can easily damage the die or substrate. Furthermore, this method is limited by the size of the static electrode. The Elastomer Stamp method uses a slightly viscous PDMS as the stamp to fine tune the speed and force of the pickup head, destroying the weak structure of the component to achieve the action of lifting it. After transfer to the target substrate, the stamp action is achieved by the adhesion difference between the two sides of the die, the fixing layer on the pickup head and the target substrate. However, in this method, the native die must be made separately. Also, although a plurality of dies can be transferred at one time, it is not possible to directly select a die or dies to be transferred. In addition, the destruction of components can easily cause the generation of fragments or particles. In the Fluidic Assembly method, the die is suspended in a liquid and a roller is rolled on the substrate to drive the fluid. Meanwhile, a fluid or gas is released by the upper matrix nozzle, which promotes the fluid disturbance of the suspended die, such that the die is dropped into the corresponding well on the substrate. However, in this method, the die shape must be specially designed, the uncertainty of fluid control is high, and the completion time is difficult to predict.

Accordingly, it is necessary to devise a new die transfer method and a die transfer system thereof to solve the problem of the prior art.

### SUMMARY OF THE INVENTION

It is a primary objective of the present invention to provide a die transfer method with the effect of using light reaction for transfer.

It is another objective of the present invention to provide a die transfer system used for the above method.

To achieve the above objectives, the die transfer method of the present invention includes the following steps: providing a wafer to generate a plurality of dies; transferring a plurality of dies to a surface of a donor substrate to temporally fix the plurality of dies on the surface of the donor substrate with a photoreactive adhesive layer; aligning the donor substrate with a target substrate, wherein the target substrate has a landing site, and the position of at least one die corresponds to the position of the landing site; irradiating the donor substrate with a beam of radiation to cause the photoreactive adhesive layer to drop the at least one die, such that the at least one die is transferred onto the landing site of the target substrate; and fixing the at least one die at the landing site.

The die transfer system of the present invention is suitable for transferring a plurality of dies. The die transfer system includes a donor substrate, a target substrate, and a light beam emitting module. The donor substrate includes a surface. The surface is provided with a photoreactive adhesive layer. Specifically, after a plurality of dies is generated from the wafer, the dies will be transferred onto the surface and will be temporally fixed by the photoreactive adhesive layer. The target substrate has a landing site. When the donor substrate is aligned with the target substrate, the position of at least one die corresponds to the position of the landing site. The light beam emitting module is used to emit a radiation beam. The radiation beam irradiates the donor substrate to cause the photoreactive adhesive layer to drop the at least one die such that the at least one die is transferred onto the landing site of the target substrate.

### BRIEF DESCRIPTION OF THE DRAWINGS

FIG. 1 is a side view of a die transfer system of the present invention;

FIGS. 2A-2C are schematic diagrams showing the transfer sequence of the die transfer system of the present invention; and

FIG. 3 is a flowchart showing the steps of a die transfer method of the present invention.

### DETAILED DESCRIPTION OF THE PREFERRED EMBODIMENT

Hereafter, the technical content of the present invention will be better understood with reference to preferred embodiments.

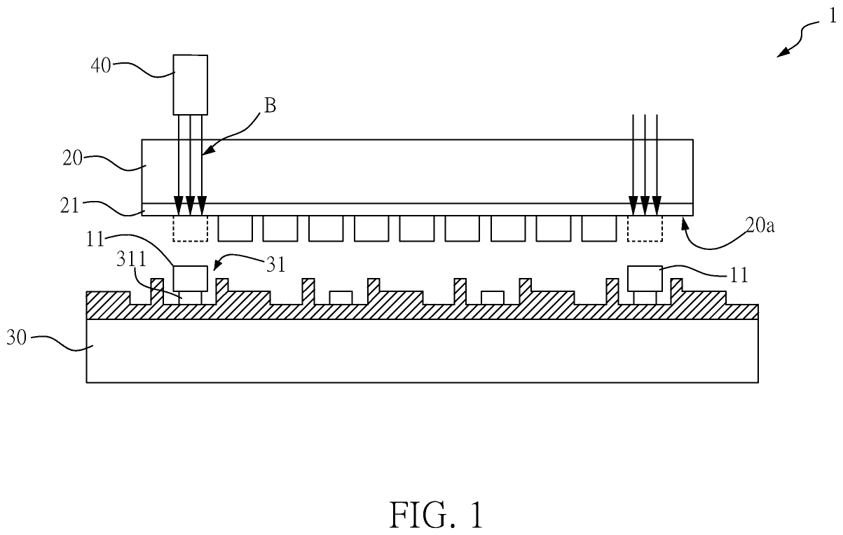

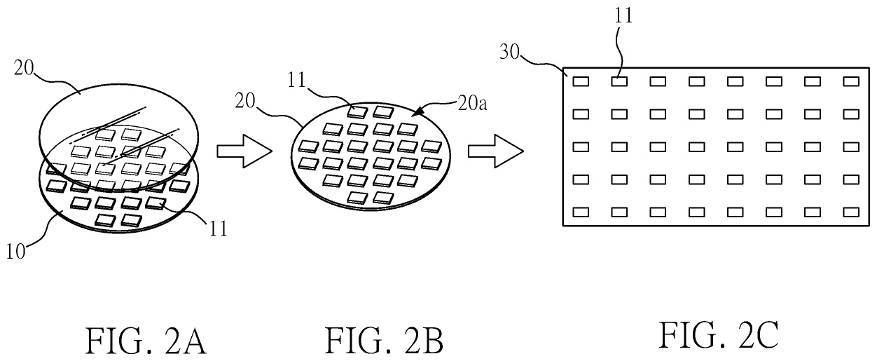

Hereafter, please refer to FIG. 1 for a side view of a die transfer system of the present invention and to FIGS. 2A-2C for schematic diagrams of the transfer sequence of the die transfer system of the present invention.

A die transfer system 1 of the present invention is applicable to transfer a plurality of dies 11 that are made from a wafer 10. Since the technique of generating the die 11 using the wafer 10 is familiar to those with ordinary skill in the art, the principle will not be described herein. The die transfer system 1 includes a donor substrate 20, a target substrate 30, and a light beam emitting module 40. The donor substrate 20 includes a surface 20a. The surface 20a is provided with a photoreactive adhesive layer 21. The photoreactive adhesive layer 21 is composed of a viscous polymer glue, which when exposed to a specific wavelength range undergoes a state change to lose adhesion or decomposes by gasification. After the die 11 is generated from the wafer 10, the die 11 is transferred onto the surface 20a through the Wafer-to-Wafer Transfer Technology, and the die 11 is then fixed by the photoreactive adhesive layer 21, such that the die 11 will not easily be dislodged, as shown in FIGS. 2A-2B.

The target substrate 30 includes a landing site 31. Specifically, when the donor substrate 20 is aligned with the target substrate 30, at least one of the dies 11 on the surface 20a corresponds to the landing site 31. The landing site 31 of the target substrate 30 is provided with a corresponding well or an adhesive layer to facilitate the placement of the die 11. In FIG. 1 of the present invention, the landing site 31 is a structure with an adhesive layer 311 plus a corresponding well, but the present invention is not limited thereto.

The light beam emitting module 40 can emit a radiation beam B. The wavelength of the radiation beam B is matched to the characteristics of the photoreactive adhesive layer 21. Therefore, when the radiation beam B irradiates the donor substrate 20, the photoreactive adhesive layer 21 on the donor substrate 20 may undergo a state change or decomposition. The scanning range of the radiation beam B can be freely set for selective transfer of a single die 11 or a plurality of dies 11 by single point focusing or scanning. The radiation beam B can also be flexibly adjusted to correspond to dies 11 of different sizes to meet the requirements of high efficiency and selectivity. In this way, a specific single die 11 or a plurality of dies 11 can be dropped, and then the at least one die 11 can be transferred onto the landing site 31 of the target substrate 30 and finally fixed to the landing site 31 with the adhesive. For example, when the electrode of the die 11 faces up, it can be fixed by light (usually UV, but not limited thereto) or heat with insulating adhesive. When the electrode of die 11 faces down, that is, it is a flip chip, then solder such as solder paste, Ball Grid Array (BGA) or Anisotropic Conductive Film (ACF) can be used, and then it is fixed onto the target substrate 30 by heat or light. Further, the die 11 and the electrode of the target substrate 30 are connected, but the present invention is not limited to the way the die 11 is fixed. As shown in FIG. 2C, a plurality of dies 11 has been completely transferred onto the target substrate 30.

It should be noted that the distance between different landing sites 31 on the target substrate 30 is M times the distance between the adjacent dies 11 on the donor substrate 20, where M is a positive integer, but the size of M is not limited in the present invention. Accordingly, the die transfer system 1 can selectively transfer the die 11 to be transferred onto the target substrate in a large amount and at a high speed on a point-by-point basis after the donor substrate 20 is in place. The donor substrate 20 can be moved to the next area, and the dies 11 can be continuously transferred until all of the dies 11 at the landing site 31 of the target substrate 30 have been transferred. If there are a plurality of target substrates 30, the dies 11 of the plurality of donor substrates 20 can be transferred onto the target substrate 30 in a large amount and at a high speed by way of partitioned synchronization or in the same area. For example, when an LED display is being manufactured, a plurality of red, blue, and green LED dies that are respectively loaded with a plurality of donor substrates 20 can be transferred onto the target substrate 30 in a large amount and at a high speed to form an LED display panel.

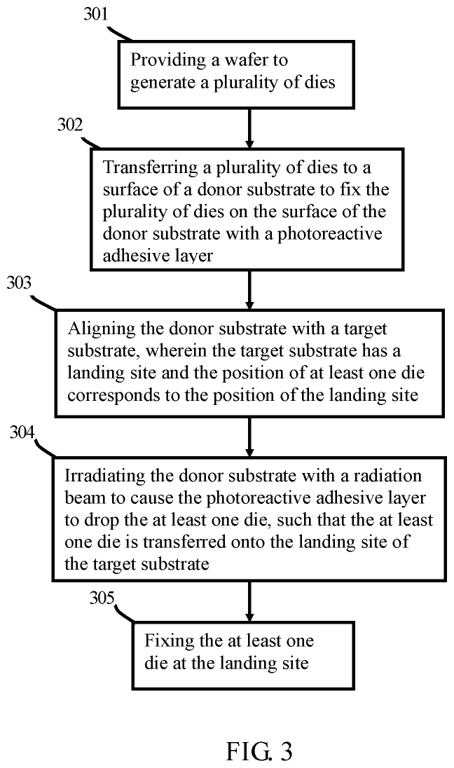

Please refer to FIG. 3, which is a flowchart showing the steps of the die transfer method of the present invention. It should be noted here that although the above die transfer system 1 is taken as an example to describe the die transfer method of the present invention, the die transfer method of the present invention is not limited to the use of a die transfer system 1 having the same structure described above.

Firstly, in Step 301: Providing a wafer to generate a plurality of dies.

At first, the wafer 10 is used to generate the plurality of dies 11.

Then, in Step 302: Transferring a plurality of dies to a surface of a donor substrate to fix the plurality of dies on the surface of the donor substrate with a photoreactive adhesive layer.

The die 11 is transferred onto the surface 20a of the donor substrate 20 by means of the wafer transfer technology, and the die 11 is fixed by the photoreactive adhesive layer 21 of the donor substrate 20, as shown in FIG. 2A-2B.

Next, in Step 303: Aligning the donor substrate with a target substrate, wherein the target substrate has a landing site and the position of at least one die corresponds to the position of the landing site.

The donor substrate 20 is aligned with the target substrate 30 such that the position of at least one die 11 on the surface 20a of the donor substrate 20 corresponds to the position of the landing site 31.

Then, in Step 304: Irradiating the donor substrate with a radiation beam to cause the photoreactive adhesive layer to drop the at least one die, such that the at least one die is transferred onto the landing site of the target substrate.

When the radiation beam B irradiates the donor substrate 20, the photoreactive adhesive layer 21 on the donor substrate 20 may undergo a state change or decomposition. Accordingly, the die 11 can be dropped, such that the die 11 can be transferred onto the landing site 31 of the target substrate 30.

Finally, in Step 305: Fixing the at least one die at the landing site.

In the last step, the die 11 is fixed at the landing site 31 by the adhesive, but the present invention is not limited to the adhesive material or the fixing method.

It should be noted here that the die transfer method of the present invention is not limited to the order of the above steps, and that the order of the above steps may be changed as long as the objective of the present invention can be achieved.

Accordingly, with the die transfer system 1 and the die transfer method of the present invention, the manufacturing can be completed at room temperature. Further, the target substrate 30 has no size or material limitations. The die transfer method of the present invention can improve efficiency and shorten the process time of group-type massive transfer. It can also be used to repair defective areas and improve the transfer yield during high-selective transfer of single or small areas.

It should be noted that the preferred embodiments of the present invention described above are merely illustrative. To avoid redundancy, not all possible combinations of changes are documented in detail. However, it shall be understood by those skilled in the art that each of the modules or elements described above may not be necessary. For the implementation of the present invention, the present invention may also contain other detailed, conventional modules or elements, each module or component is likely to be omitted or modified depending on variable needs, and other modules or elements may not necessarily exist between any two of the modules, all without departing from the scope of the invention as defined solely by the appended claims.

What is claimed is:

1. A die transfer method, comprising the following steps:
providing a wafer to generate a plurality of dies;
transferring a plurality of dies to a surface of a donor substrate to fix the plurality of dies on the surface of the donor substrate with a photoreactive adhesive layer;
aligning the donor substrate with a target substrate, wherein the target substrate has a landing site, and the position of at least one die corresponds to the position of the landing site;
irradiating the donor substrate with a radiation beam to cause the photoreactive adhesive layer to drop the at least one die, such that the at least one die is transferred onto the landing site of the target substrate; and
fixing the at least one die at the landing site.

2. The die transfer method as claimed in claim 1, further comprising the following step:
forming the photoreactive adhesive layer of a viscous polymer glue.

3. The die transfer method as claimed in claim 1, further comprising the following step:
providing a corresponding well or an adhesive layer on the landing site of the target substrate.

4. The die transfer method as claimed in claim 1, wherein the distance between different landing sites on the target substrate is M times the distance between adjacent dies on the donor substrate, where M is a positive integer.

5. A die transfer system, suitable for transferring a plurality of dies, the die transfer system comprising:
a donor substrate which is highly transparent to the light source, having a surface provided with a photoreactive adhesive layer; after the dies are generated from a wafer, the dies are transferred onto the surface to fix the plurality of dies with the photoreactive adhesive layer;
a target substrate, having a landing site, wherein the donor substrate is aligned with the target substrate and the position of the at least one die corresponds to the location of the landing site; and
a light beam emitting module for emitting a radiation beam, wherein the radiation beam irradiates the donor substrate and causes the photoreactive adhesive layer on the donor substrate to drop the at least one die, thereby transferring the at least one die onto the landing site of the target substrate.

6. The die transfer system as claimed in claim 5, wherein the photoreactive adhesive layer is composed of a viscous polymer glue.

7. The die transfer system as claimed in claim 5, wherein the landing site of the target substrate is provided with a corresponding well or an adhesive layer.

8. The die transfer system as claimed in claim 5, wherein the distance between different landing sites on the target substrate is M times the distance between adjacent dies on the donor substrate, where M is a positive integer.
